(19) United States
(12) Patent Application Publication
(10) Pub. No.: US 2026/0231294 A1
(43) Pub. Date: Aug. 6, 2026

(54) SYSTEM FOR OPERATING A HEATING DEVICE OF A CAMERA FOR A MOTOR VEHICLE

(71) Applicant: CONNAUGHT ELECTRONICS Ltd., Tuam (IE)

(72) Inventors: John Otoole, Tuam (IE); Gaspar Mihalik, Tuam (IE)

(73) Assignee: CONNAUGHT ELECTRONICS Ltd., Tuam, County Galway (IE)

(21) Appl. No.: 19/150,863

(22) PCT Filed: Jan. 10, 2024
(86) PCT No.: PCT/EP2024/050444

§ 371 Date: Jul. 24, 2025

(30) Foreign Application Priority Data
Jan. 24, 2023 (DE) 10 2023 101 597.4

(51) Int. Cl. H05B 1/02; B60S 1/02; B60S 1/56; G03B 17/55

(52) U.S. Cl. CPC H05B 1/0202; G03B 17/55; B60S 1/026; B60S 1/56

(57) ABSTRACT

Described is a system for operating a heating device of a camera for a motor vehicle. The system includes a control device and an electronic circuit of the camera. The electronic circuit includes a switch for the heating device and a voltage regulator device having a primary voltage regulator and a secondary voltage regulator. The control device is configured to provide a voltage to the primary voltage regulator. The primary voltage regulator reduces the voltage provided to the switch to a constant voltage level. The system is configured to operate the heating device with the provided reduced voltage.

The invention relates to a system for operating a heating device of a camera for a motor vehicle, wherein the system includes a control device and an electronic circuit of the camera. In addition, the invention relates to a motor vehicle with a camera and such a system as well as to a method for operating a heating device of a camera for a motor vehicle by means of such a system.

A motor vehicle may comprise at least one camera such as for example a front camera, rear camera and/or side camera, which is configured to capture an environment of the motor vehicle. Alternatively or additionally thereto, the camera may be an interior camera, which is configured to capture an interior of the motor vehicle. In addition, the motor vehicle may have an at least partially autonomous, in particular fully autonomous, driving function. This driving function often requires data captured and provided by the camera, in particular such data, which describe the environment of the motor vehicle.

If fogging of a camera objective of the camera with condensed water and/or coverage of the camera objective with ice and/or snow occurs, the data provided by the camera possibly do not describe the environment reliably enough to be able to provide the driving function. Therefore, measures are to be taken to clean the camera objective and in particular the lens of the camera. These measures are for example based on a warm water jet or comprise a heating device for the camera. In order to avoid an additional water supply system for providing the warm water jet, the heating device is preferably integrated in the camera. The heating device may for example be arranged between the camera objective or lens module of the camera and a circuit board, to which an image sensor of the camera is for example coupled. Such a heating device is inexpensive and additionally does not have an influence on an exterior configuration of the camera compared to the described measure based on the warm water jet.

From the prior art, numerous cameras for motor vehicles with heating devices are known.

US 2020/0314311 A1 shows a vehicle camera for a vehicle vision system, which includes a housing with a front housing part and a rear housing part, wherein the front housing part comprises a camera objective. A heating device is arranged on an outermost lens element of the camera objective.

DE 10 2021 201 370 A1 shows a method for heating a lens of a camera objective, in which circulating or eddy currents are generated in an electrically conductive member integrated in the camera objective using at least one coil such that the electrically conductive member heats.

US 2020/0192085 A1 shows a heating device including a primary induction coil and a secondary induction coil. The primary induction coil generates a magnetic field in response to the reception of electrical energy and the secondary induction coil overlies the primary induction coil, wherein the secondary induction coil finally heats a camera objective when the primary induction coil obtains the electrical power.

US 2018/0017785 A1 shows a heating system for preventing fog and ice formation on driver assistance cameras. A heating element is in communication with an air gap between a camera objective and a transparent window to heat the transparent window without blocking an image received by the camera objective.

However, details to the electronic control of the heating device of the camera are not found in the prior art.

It is the object of the invention to provide a solution, by means of which a heating device of a camera for a motor vehicle may be reliably controlled.

The object is solved by the subject matters of the independent claims.

A first aspect of the invention relates to a system for operating a heating device of a camera for a motor vehicle. The heating device is a component of the camera and for example positioned within the camera between a camera objective or lens module of the camera and an image sensor of the camera, which is for example arranged on a circuit board of the camera. Alternative or additional arrangements of the heating device in the camera are possible. Alternatively, the heating device may be referred to as heater or heating element. Preferably, the camera is a front camera, a rear camera, a side camera and/or an interior camera of the motor vehicle. The camera is configured to capture its environment, which is preferably an environment of the motor vehicle. Therefore, the camera for example captures and provides static image data or video image data. The image data is for example evaluated in the motor vehicle, for example for a partially autonomous, in particular fully autonomous, driving function of the motor vehicle, which is in particular provided by a driver assistance system of the motor vehicle.

The system includes a control device and an electronic circuit of the camera. Preferably, the control device is a component of the motor vehicle, which is arranged external to the camera and thus is not a component of the camera. Alternatively, the control device may be referred to as electronic control unit of the motor vehicle. The electronic circuit comprises at least one switch for the heating device. The switch for the heating device is for example configured to activate or to deactivate the heating device depending on a control command provided to it. In addition, the electronic circuit comprises a voltage regulator device. Alternatively, the voltage regulator device may be referred to as voltage regulator. The voltage regulator device comprises a primary voltage regulator and in particular at least one secondary voltage regulator. Alternatively, the primary voltage regulator may be referred to as main voltage regulator. Alternatively, the at least one secondary voltage regulator may be referred to as auxiliary voltage regulator. The voltage regulator device may be understood as a component of the electronic circuit, which may include multiple individual voltage regulators.

The invention is at least based on the realization that in a motor vehicle, for example to save cost and/or installation space, the heating device is supplied with energy by the same supply cable as the remaining components of the camera, such as the image sensor or further electronic components of the camera. The supply cable is for example a power over coax cable, a shielded twisted pair and/or an Ethernet cable. The supply cable is for example included in a harness of the motor vehicle. Since a large amount of energy is typically transferred via the harness within the motor vehicle, which is for example at least larger than the amount of energy required by the camera, the system should comprise an input filter, which is configured to be operated with such amounts of energy. Further, an energy supply of the heating device should be monitored, especially if a voltage provided to the camera with the heating device fluctuates according to position of the camera in the motor vehicle and/or in time. The fluctuations for example arise because a length of the supply cable and thus for example of the harness may fluctuate depending on how far the camera is apart from the control device, and thus according to the position of the camera in the motor vehicle. In addition, temporally varying fluctuations in a supply voltage, which is provided by the control device, may for example occur. Further, the heating device should be configured in an installation space saving manner and therefore only comprise small-sized electronic components.

The control device of the system may be configured to increase a minimum supply voltage, which is at least provided by the control device for the camera, to a preset minimum supply voltage value. According to a configuration of the motor vehicle, a voltage source in the motor vehicle may for example provide a voltage of 12 Volts or for example of 16 Volts. A typical minimum supply voltage is then for example at 7 Volts to 9 Volts. This typical minimum supply voltage may now be increased to a supply voltage according to the preset minimum supply voltage value. It is for example between 12 Volts and 16 Volts, in particular at 13 Volts to 15 Volts. Alternative values to the mentioned voltage values are possible.

It is assumed that the control device of the motor vehicle provides the energy supply of the camera. Hereto, a voltage source in the motor vehicle such as a battery may for example supply the control device with energy. The control device may perform adjustments to preset the minimum supply voltage for the camera. By increasing the minimum supply voltage to a higher preset minimum supply voltage value, a maximum current, which is provided to the camera, may be reduced. This accomplishes that the harness leading to the camera may for example be configured thinner and may deal with more losses compared to a configuration, in which a low minimum supply voltage is provided. Thus, the previously described fluctuations may be at least partially compensated for.

The control device is configured to provide a voltage to the primary voltage regulator of the voltage regulator device. If the minimum supply voltage is increased, the provided voltage may at least correspond to the minimum supply voltage. The primary voltage regulator is configured to reduce the voltage, which is provided to the switch, to a constant voltage level. The constant voltage level may alternatively be referred to as constant voltage value. The primary voltage regulator provides the voltage to the switch. This means that the current, which is required for operating the heating device, is not directly provided at a camera terminal, but is provided to the camera and thus also to the heating device of the camera via the voltage regulator device. The primary voltage regulator may reduce the voltage provided to it to a preset voltage value and thus to a preset level, wherein this level may be lower than the voltage typically provided at the camera terminal. Therefore, the voltage regulator device may alternatively be referred to as step down voltage regulator. In the above mentioned example, the voltage provided to the voltage regulator device is at least 12 Volts to 16 Volts due to the increased minimum supply voltage. The primary voltage regulator of the voltage regulator device then reduces the voltage to for example 4 Volts to 6 Volts, wherein it keeps this low voltage constant. The low voltage provided by the primary voltage regulator is provided to the switch of the heating element, which thereupon provides or uses it for operating the heating device. The advantage hereof is in that the energy supply of the heating device is kept constant independently of the fact how long the harness is formed or which voltage the control device currently provides. Herein, it is always assumed that the voltage, which arrives at the voltage regulator device, satisfies the preset minimum requirements, that is at least the preset minimum supply voltage value.

The at least one secondary voltage regulator may for example be configured to further reduce the voltage provided to it. Hereby, it is for example possible to provide an even lower voltage to the image sensor of the camera and/or another electronic component of the camera than to the heating device, which is for example around 2 Volts. Thus, the at least one secondary voltage regulator is preferably not configured to provide a voltage for the heating device, but only for further electronic components of the camera. Thus, the primary voltage regulator is preferably the only component of the voltage regulator device, which supplies the heating device with energy. That only the primary voltage regulator is used for the heating device, effectuates that both installation space and cost may be saved. Further, additional voltage regulators in the camera, which are only provided for the heating device, may be avoided. Therefore, it is particularly reasonable to use the voltage regulator device with the multiple voltage regulators and to provide the primary voltage regulator thereof only for the energy supply of the heating device.

The system is configured to operate the heating device with the provided reduced voltage. Thus, it is finally achieved with the system by the described influences on the minimum supply voltage as well as the voltage provided to the switch of the heating device that the heating device may be reliably operated in simple manner since an advantageously chosen and additionally constant voltage supply is realized for it. Thus, the heating device of the camera for a motor vehicle may be reliably controlled.

An embodiment provides that the electronic circuit comprises a state determining device, which is configured to determine a state information describing a current state of the heating device. The state information may for example describe a current, a voltage and/or a temperature, which at least partially or directly relate to the heating device. The state determining device is configured to provide the determined state information to the control device and/or a control unit of the electronic circuit. The control unit may be a component of the camera and thus for example be integrated in the electronic circuit. The control device and/or the control unit are configured to provide a control command for the heating device depending on the provided state information. If the determined state information is provided to the control device, the control device provides the control command. If the state information is provided to the control unit, the control unit provides the control command.

This embodiment is at least based on the realization that a state of the heating device should be monitored, in particular with respect to a current, a voltage, a power, an actual resistance of the heating device and/or a temperature. Preferably, the monitoring should be possible in remotely controlled manner, for example by means of the control device. The monitoring is particularly reasonable if an at least partially autonomous, in particular fully autonomous, driving function is used in the motor vehicle since a state of the camera and thus a reliability, with which it provides the image data, is then always known or at least determinable. In addition, a level of the energy supply should be able to be again and again adapted during an operation of the heating device to for example be able to consider varying environmental conditions, such as for example temperature variations. For these reasons, the state determining device is provided, which determines and provides the state information.

The control command may at least relate to activation or deactivation of the heating device. Further, the control command may relate to a control and/or regulation of the heating device in differentiated manner that is for example to preset a temperature increase or temperature decrease, which is to be implemented by the heating device. Thus, a monitoring function is provided, in which the state of the heating device is determined by determining the state information, in particular in continuous manner, such that the heating device may be controlled according to the corresponding control command depending thereon. Thus, the current state of the heating device is evaluated for actuation and/or control thereof in the future.

According to an additional embodiment, it is provided that the state determining device comprises at least one current sense resistor with a preset resistance connected in series with the heating device and an analog-to-digital converter. The state determining device may then be referred to as current determining device. The state determining device thus comprises at least the current sense resistor and the analog-to-digital converter. The state determining device is configured to capture a voltage dropping on the current sense resistor by means of the analog-to-digital converter. In addition, the preset resistance is known by the current sense resistor. Considering the captured voltage and the preset resistance, a current value may thereupon be determined as the state information since the voltage is the product of current and resistance. The current value describes the current provided to the heating device. Thus, an inexpensive possibility realizable with low effort is provided to determine the actual current value as the state information.

A further embodiment provides that the state determining device comprises at least one electronic switch, in particular a chip, which comprises an integrated current measuring function. The state determining device is configured to determine a current value as the state information by means of the current measuring function. Thus, it is possible to resort to an already prefabricated electronic component, which directly measures the current, such that it for example does not have to be elaborately calculated from the voltage and the resistance such as described above. Hereto, it may be resorted to conventional and thus known members with the current measuring function, which may be particularly inexpensive and economical in installation space.

In addition, an embodiment provides that the state determining device comprises at least one analog-to-digital converter. It is coupled to a positive terminal of the heating device. The state determining device is configured to determine a voltage value as the state information based on the analog-to-digital converter. The voltage value describes the voltage currently provided to the heating device. Thus, it may be resorted to relatively inexpensive components economical in installation space to perform a voltage measurement.

Based on at least one of the described captures of the current value as the state information and/or the described ascertainment of the voltage value as the state information, the energy consumption of the heating device and/or the actual resistance of the heating device may further be calculated. Monitoring the energy consumption as well as the resistance of the heating device thus does not require a state determining device specifically provided thereto, but only an evaluation of the current value and the voltage value, for example by means of the control device and/or the control unit.

A further embodiment includes that the control device and/or the control unit are configured to examine if the determined state information is outside of a preset value range. The preset value range is in particular depending on state information that is different for the current value than for the voltage value. The control device and/or the control unit are configured, if this is the case, that is if the determined state information is outside of the preset value range, to provide an error message and/or to provide a control command, which presets that the heating device is at least paused, in particular deactivated. In pausing, the heating device is not completely deactivated, but for example set into a sleep mode and/or deactivated only for a preset time window.

Thus, the control device and/or the control unit are configured to examine the determined state information and optionally to report it by means of the error message and/or to provide the control command: For example, if a low current value is present, which is lower than a lower value of the corresponding value range, it is possible that the heating device cannot be operated at all. Then, a corresponding error message may be provided, which for example describes that the heating device is currently not available. For example, if the voltage value is higher than an upper value of the corresponding value range presets, an overload of the electronic components of the camera could occur such that the in particular immediate deactivation of the heating device may for example be reasonable. Further, an error message may be provided at the same time or alternatively thereto, which for example describes that the heating device is currently no longer available. The error message is for example output on an output device in the motor vehicle. For example, it includes a display device such as for example an in particular touch-sensitive screen, a head-up display and/or another device including a display surface. Alternatively or additionally thereto, the error message may be effected as an acoustic voice output by means of a speaker device with at least one speaker in the motor vehicle. Further, the error message may be communicated to a mobile terminal, which is arranged in the motor vehicle and/or is at least associated with a user of the motor vehicle, such that the error message may be output by means of the mobile terminal. The mobile terminal is for example a smartphone and/or a tablet.

Thus, measures are taken if the monitored current and/or voltage values indicate that an error and/or a malfunction relating to the heating device of the camera have occurred. This allows a reliable feedback to the user as well as taking for example required protective measures like deactivating the heating device.

Furthermore, an embodiment provides that the state determining device comprises at least one temperature sensor. The state determining device is configured to determine a temperature value as the state information by means of the temperature sensor. The temperature value describes a temperature, in particular a temperature in the camera and/or in the spatial proximity to the camera. In order to monitor the temperature in the camera and/or in the environment thereof, thus, an elaborative calculation is not performed, but a temperature sensor is provided as a component of the system hereto. The temperature value is a particularly relevant quantity to determine when the heating device should be activated or deactivated. For this reason, the described state determining device for determining the temperature value as the state information is particularly reasonable.

According to an additional embodiment, it is provided that the temperature sensor of the state determining device is arranged within the camera such that the determined temperature value describes an inside temperature of the camera. Hereto, the temperature sensor may for example be arranged in the camera objective or lens module of the camera, in a clearance between the camera objective and a circuit board of the camera, in a spatial proximity to the image sensor and/or at another location within a housing of the camera. Thus, the actual temperature in the camera may be monitored. Preferably, the temperature sensor is arranged at or spatially close to a temperature-sensitive electronic component of the camera such that it may timely capture a temperature increase of a temperature of this or at this component.

Alternatively or additionally thereto, the camera may be configured as an environmental temperature sensor. In this case, the temperature sensor is typically arranged outside of the camera. The environmental temperature sensor may for example be a temperature sensor associated with an air conditioning system of the motor vehicle. The environmental temperature sensor is installed in the motor vehicle. If the camera is configured as an environmental temperature sensor, the determined temperature value describes an environmental temperature of an environment of the camera. Preferably, the environment of the camera is an environment of the motor vehicle. Then, an outside temperature of the motor vehicle is captured. That is, the temperature sensor describes the outside temperature.

Then, it may be directly taken from the outside temperature and/or be estimated based on the inside temperature whether or not an operation of the heating device is necessary. For example, it could be necessary whenever the temperature value is below the freezing point, in particular below 0 degrees Celsius, since it may then be assumed that an activation of the heating device of the camera is reasonable to for example melt away or not to allow to develop ice and/or snow on the camera objective.

Further, it is possible that the two possible arrangements of the temperature sensor are implemented, that is that at least two temperature sensors are provided. Then, a comparison between the inside temperature and the environmental temperature or outside temperature may for example be effected to be able to particularly reliably determine whether or not heating the camera and in particular the camera objective is reasonable.

In addition, it is provided in an embodiment that the control device and/or the control unit are configured to examine if the determined temperature value is less than a preset minimum temperature threshold, and only if this is the case, that is only if the determined temperature value is less than the preset minimum temperature threshold, to provide a control command, which presets that the heating device is activated. Thus, it may in particular be provided that this examination of the provided temperature value is effected before the voltage value and/or the current value are determined at all, for example by means of the corresponding state determining device. Thus, it may be provided that monitoring is first effected only by means of the state determining device for determining the temperature value and only after the heating device was activated, the further additional information is transferred and thus monitored.

For example, it may be provided that the minimum temperature threshold is at 0 degree Celsius and thus at the freezing point of water. Further, a temperature below the freezing point, for example of minus 1 degree Celsius, minus 3 degrees Celsius, minus 5 degrees Celsius or in particular minus 10 degrees Celsius, may be provided as the minimum temperature threshold. Further, the minimum temperature threshold may be above the freezing point, for example at 1 degree Celsius, 3 degrees Celsius, 5 degrees Celsius or in particular 10 degrees Celsius. Alternative minimum temperature thresholds are possible, which may for example be between the mentioned values. In other words, the temperature sensor is used to determine if activation of the heating device and thus heating the components of the camera are to be effected.

An additional embodiment provides that the control device and/or the control unit are configured to continuously examine if the determined temperature value is greater than a preset maximum temperature threshold with activated heating device. The preset maximum temperature threshold is greater than the minimum temperature threshold. The control device and/or the control unit are further configured, if this is the case, meaning that if the determined temperature value is greater than the preset maximum temperature threshold, to provide an error message and/or a control command. The control command presets that the heating device is at least paused, in particular deactivated. Thus, it is possible to determine an overheating of the camera based on the evaluation of the temperature value. Preferably, the maximum temperature threshold is chosen such that it prevents a damage of the electronic components of the camera by the heating device. For example, the maximum temperature threshold may be at 125 degrees Celsius. Alternative maximum temperature thresholds are possible, which may be above or below the mentioned value. The provided error message may be effected analogously as it was already described in context of the current value and the voltage value. A user of the motor vehicle may thus be informed about the caused or imminent overheating of the camera electronics. Alternatively to deactivating or pausing the heating device, a reduction of the temperature may be preset by the control command. Finally, it may be monitored if the temperature value remains in a preset value range, which is limited by the minimum temperature threshold and the maximum temperature threshold.

The temperature sensor may have a function, which is configured to determine an air humidity. Alternatively or additionally thereto, the state determining device may include an air humidity measuring unit. Then, it cannot only be determined if ice and/or snow are located on the camera objective, but fogging of the camera objective may be predicted and/or measured, for example with an arrangement of the air humidity measuring unit in the camera. Then, countermeasures may be effected, such as for example an increase of a heating power of the heating device according to a corresponding control command.

In a further embodiment, it may be provided that the system is configured to adjust the energy, with which the heating device is supplied, by means of an adjustable voltage regulator included by the electronic circuit and/or a pulse width modulation. Herein, it is assumed that is may be at least partially required to adapt the energy supply of the heating device. This may be provided to compensate for various external temperature conditions. Alternatively or additionally thereto, this may be effected due to internal restrictions, for example due to a restriction of a current supply of the heating device. The two possible approaches, which are particularly suitable here, to adapt the energy, which is provided to the heating device, either in startup or during an operation of the heating device, are the use of the adjustable voltage regulator and/or the pulse width modulation. Hereto, it may be resorted to already known methods for pulse width modulation.

Further, it may be provided that the system comprises an interface, via which the control device is connected to the electronic circuit of the camera. The interface is in particular configured as a seralizer-deserializer interface. Hereby, a particularly reliable communication link between the control device and the electronic components of the camera, that is at least the components of the electronic circuit for operating the heating device, may be provided.

A further embodiment provides that the electronic circuit comprises an integrated circuit for energy management. Alternatively, it may be referred to as power management integrated circuit (PMIC). The power management integrated circuit is configured to preset any voltage provided to the camera. In particular a primary voltage regulator of the power management integrated circuit is configured to supply at least the at least one secondary voltage regulator of the voltage regulator device and/or the switch of the heating device with energy. Thereupon, the switch of the heating device may preset, which energy flow to the heating device is effected. By using the power management integrated circuit, the energy supply for example for the switch of the heating device may be realized in space saving and inexpensive manner.

An additional aspect of the invention relates to a motor vehicle. The motor vehicle comprises a camera with a heating device. In addition, the motor vehicle comprises a system, as it was described above. This means, the motor vehicle comprises at least the control device, the camera as well as the electronic circuit. For example, the motor vehicle is a passenger car, a truck, a bus, a motorcycle and/or a motorbike. It is possible to consider the camera as a component of the system. For example, the control device is a central control device, which is configured to provide a driver assistance system and/or a comfort function of the motor vehicle. Thus, the control device cannot only be configured for energy supply as well as optionally for control of the camera and of the heating device, respectively.

An advantageous embodiment of the motor vehicle according to the invention provides that the control device is a control device of the motor vehicle external to camera. The control unit is a microcontroller integrated in the electronic circuit. Thus, it is possible that the determined voltage value, current value and/or temperature value are for example locally monitored in the camera by means of the microcontroller as the control unit. Alternatively or additionally thereto, the monitoring of these values may be effected remotely controlled via the control device and thus external to camera. The microcontroller and/or the control device of the motor vehicle may evaluate the additional information provided to them and/or control the heating device.

The control device comprises a processor device. The processor device may comprise at least one microprocessor and/or at least one microcontroller and/or at least one FPGA (Field Programmable Gate Array) and/or at least one DSP (Digital Signal Processor). Furthermore, the processor device may comprise program code, which may alternatively be referred to as computer program product. The program code may be stored in a data storage of the processor device.

An additional aspect of the invention relates to a method for operating a heating device of a camera for a motor vehicle by means of a system of a control device and an electronic circuit of the camera, wherein the electronic circuit comprises at least one switch for the heating device and a voltage regulator device, which comprises a primary voltage regulator and in particular at least one secondary voltage regulator. The method may include increasing a minimum supply voltage, which is provided at least by the control device for the camera, to a preset minimum supply voltage value. The method includes providing a voltage for the primary voltage regulator of the voltage regulator device by means of the control device. Furthermore, the method includes reducing the voltage, which is provided to the switch of the heating device, to a constant voltage level by means of the primary voltage regulator and operating the heating device with the provided reduced voltage.

The embodiments described in context of the system according to the invention, each individually as well as in combination with each other, correspondingly apply, if applicable, to the motor vehicle according to the invention and the method according to the invention. The invention includes combinations of the described embodiments.

There show:

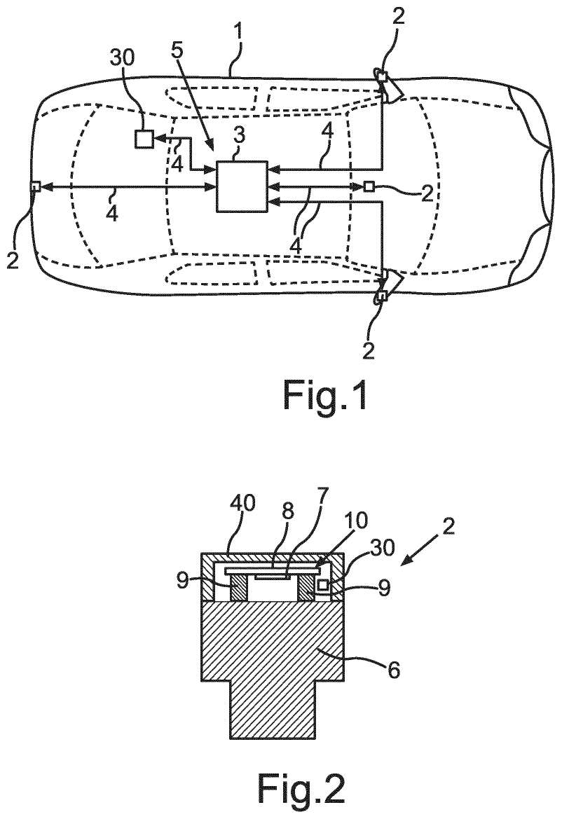

FIG. 1 a schematic representation of a motor vehicle with multiple cameras;

FIG. 2 a schematic representation of a camera with a heating device for a motor vehicle;

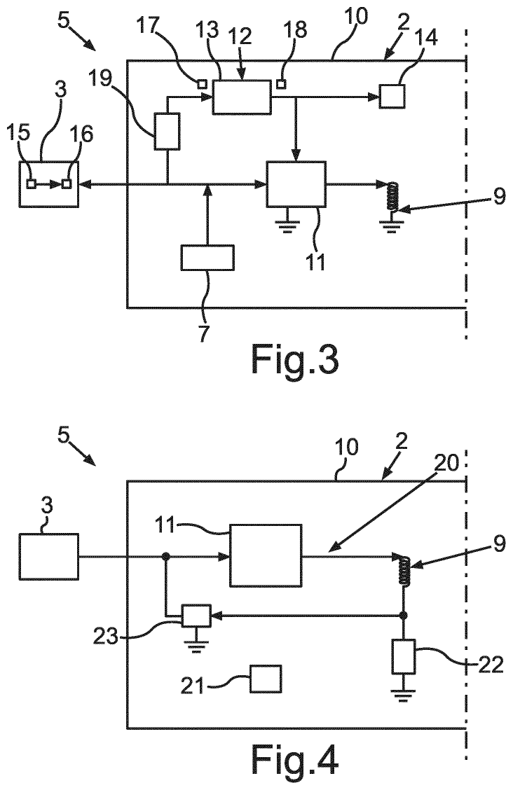

FIG. 3 a schematic representation of a system for operating a heating device of a camera;

FIG. 4 a schematic representation of a state determining device for determining a current value;

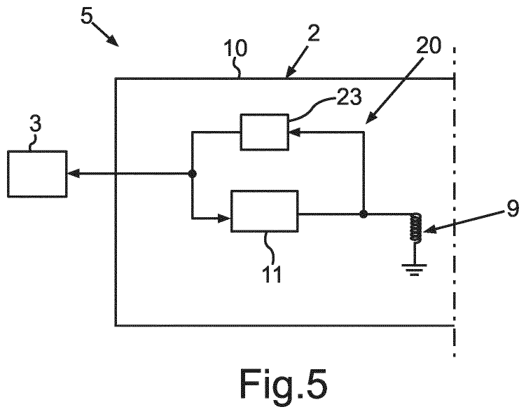

FIG. 5 a schematic representation of a state determining device for determining a voltage value

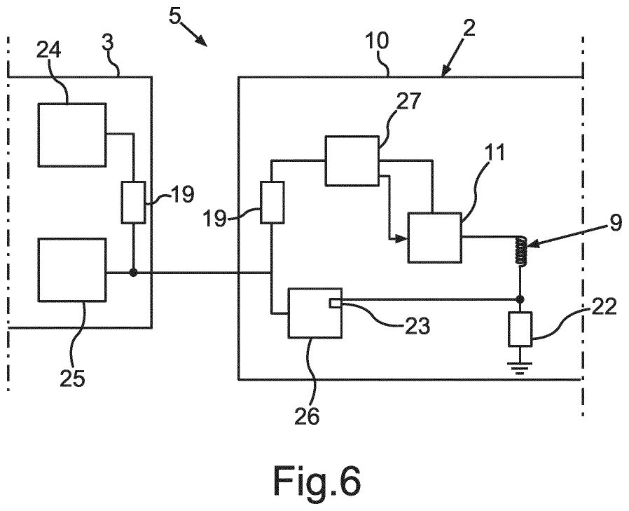

FIG. 6 a schematic representation of details of this system according to FIG. 3; and

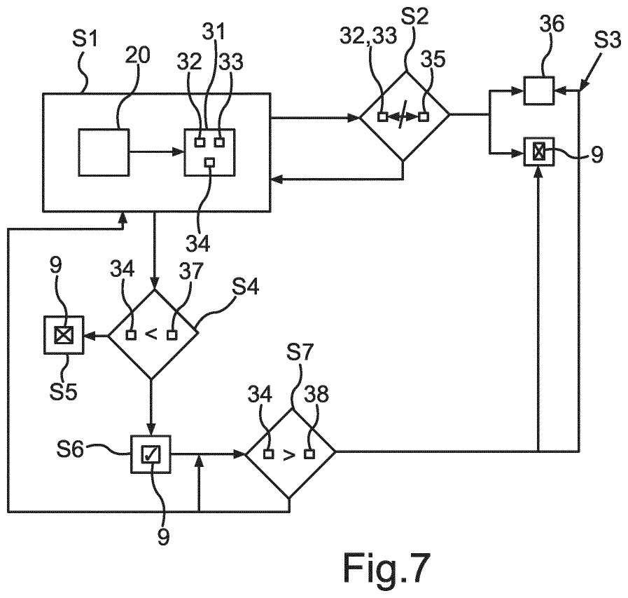

FIG. 7 a schematic representation of a method for operating a heating device depending on the provided state information.

FIG. 1 shows a motor vehicle 1, which includes multiple cameras 2. Here, a front camera arranged at an upper end of a windshield, two side cameras arranged in side mirrors of the motor vehicle 1, as well as a rear camera in a rear area of the motor vehicle 1 are purely exemplarily outlined as the possible cameras 2. Alternatively or additionally thereto, a camera 2 may be arranged in the interior of the motor vehicle 1. Other arrangements of the cameras 2 are possible.

The motor vehicle 1 comprises a control device 3, which is for example a central control device 3 of the motor vehicle 1. Connections 4 are provided between the control device 3 and the respective camera 2 of the motor vehicle 1. The connections 4 may be formed as a harness. The respective camera 2 may be supplied with energy and/or receive and/or transfer data from or to the control device 3 via the respective connection 4. A battery may be provided in the motor vehicle 1, which supplies the control device 3 with electrical energy (here not outlined). The motor vehicle 1 comprises a system 5, which includes at least the control device 3 as well as individual components of the respective camera 2 and the connections 4.

Further, the motor vehicle 1 may comprise a temperature sensor 30. It may be an environmental temperature sensor, which is configured to capture a temperature of the environment of the motor vehicle 1. Alternatively or additionally thereto, the temperature sensor 30 may be a component of the camera 2 and be configured to capture an inside temperature of the camera 2. The arrangement of the temperature sensor 30 in the motor vehicle 1 is to be purely exemplarily understood, that is other arrangements of the temperature sensor 30 are possible.

FIG. 2 shows an example for a possible configuration of the respective camera 2. Here, the camera 2 comprises a camera objective 6, which includes at least one lens and is configured to gather light from the environment of the camera 2 and output it towards an image sensor 7. It may for example be arranged on a circuit board 8. Further, between the circuit board 8 and an output of the camera objective 6 internal to camera, which faces the image sensor 7, a heating device 9 may be arranged. It may for example be arranged annularly around the opening of the camera objective 6. Further, an electronic circuit 10 may be provided, which is for example arranged on the circuit board 8 or at least partially included by it. Further, the camera 2 may comprise a housing 40, which delimits the described electronic components as well as the image sensor 7 from the environment. Other configurations of the camera 2 are possible, in which the heating device 9 is in particular arranged at a different location within the camera 2.

FIG. 3 shows the system 5, which is configured for operating the heating device 9 of the camera 2. The system 5 includes at least the control device 3 of the motor vehicle 1 and the electronic circuit 10 of the camera 2. The heating device 9 or even the entire camera 2 may for example be understood as a part of the system 5. The system 5 comprises connections 4 between components of the system 5 as for example at least partially sketched in FIG. 3.

The electronic circuit 10 comprises at least one switch 11 for the heating device 9. In addition, it comprises at least one voltage regulator device 12. It comprises a primary voltage regulator 13 and in particular as well at least one and preferably multiple secondary voltage regulators 14. The control device 3 may be configured to increase a minimum supply voltage 15, which is at least provided by the control device 3 for the camera 2, to a preset minimum supply voltage value 16. Herein, the minimum supply voltage 15 may for example be increased from typical 7 Volts to 9 Volts to for example 12 Volts to 16 Volts. As a result, the voltage provided to the primary voltage regulator 13 may be at least as high as the increased minimum supply voltage 15. The primary voltage regulator 13 is configured to provide a voltage to the switch 11. It is configured to reduce this voltage, which it provides to the switch 11, to a constant voltage level 18, for example of 4 Volts to 6 Volts. Here, an output voltage 17 is provided to the primary voltage regulator 13. Typically, the minimum supply voltage value 16 is always higher than the output voltage 17 due to occurring voltage drops across the connection 4 and/or a power over coax filter 19. The primary voltage regulator 13 in configure to supply a voltage of the constant voltage level 18 by considering the relation between the minimum supply voltage value 16 and the output voltage 17. The primary voltage regulator 13 provides the voltage with the constant voltage level 18 to the switch 11 of the heating device 9. Thus, the system 5 is configured to operate the heating device 9 with the provided reduced voltage that is with the voltage according to the constant voltage level 18. The system 5 in hence configured to handle different output voltage levels by maintaining the power on the heater 9 constant even if the voltage drops across the connections 4 (for example across the harness) and/or the power over coax filter 19 varies.

The at least one secondary voltage regulator 14 may be configured to supply further components of the camera 2 with energy. The electronic circuit 10 may comprise the power over coax filter 19, which is part of the circuit 10 to provide the energy from the control device 3 for the camera 2.

FIG. 4 shows a state determining device 20, which may be included by the electronic circuit 10. The state determining device 20 is configured to determine state information 31 (see reference character 31 in FIG. 7), wherein the state information 31 describes a current state of the heating device 9. Further, the determined state information 31 is provided to the control device 3 and/or a control unit 21, which may for example be a microcontroller integrated in the camera 2. The control unit 21 is thus a component of the electronic circuit 10. The control device 3 and the control unit 21, respectively, are configured to provide a control command for the heating device 9 depending on the provided state information 31, that is for example to activate, deactivate, pause it and/or to preset for example a certain temperature to it.

Here, a current value is determined as the state information 31 by means of the state determining device 20. Hereto, the state determining device 20 comprises at least one current sense resistor 22 connected in series with the heating device 9. In addition, it comprises an analog-to-digital converter 23. The state determining device 20 is configured to capture a voltage drop across the current sense resistor 22 by means of the analog-to-digital converter 23. In addition, the resistance of the current sense resistor 22 is known. Considering the captured voltage and the preset resistance of the current sense resistor 22, the current value is determined as the state information 31.

Alternatively or additionally thereto, it is possible that an electronic switch, which is for example configured as a chip, is provided, which has an integrated current measuring function, instead of the described current sense resistor 22 and the analog-to-digital converter 23. The current value may then be determined as the state information 31 by means of it. Alternatively or additionally, an external current sensing device may be provided to determine the current value. The external current sensing device may be a separate current measuring integrated chip.

FIG. 5 shows an alternative or additional state determining device 20, by means of which a voltage value may be determined. Here, the state determining device 20 comprises at least one analog-to-digital converter 23, which is coupled to a positive terminal of the heating device 9. The state determining device 20 is configured to determine a voltage value as the state information 31 by means of the analog-to-digital converter 23.

Further, it is possible that the state determining device 20 comprises at least the temperature sensor 30 and is configured to determine a temperature value as the state information 31 by means of the temperature sensor 30. The temperature sensor 30 used hereto may be arranged within the camera 2. Hereto, it may be arranged in the camera objective 6, for example in the vicinity of a lens of the camera objective 6. Alternatively or additionally thereto, the temperature sensor 30 may be arranged on the circuit board 8 and/or one of the further electronic components of the electronic circuit 10. Finally, either an inside temperature of the camera 2 and/or an environmental temperature of the environment of the camera 2 and preferably of the motor vehicle 1 may be captured with the temperature sensor 30.

FIG. 6 shows a concrete configuration of the system 5. Here, the control device 3 comprises an energy supply 24 as well as the power over coax filter 19. Further, an interface is provided between the control device 3 and the electronic circuit 10, which allows that the control device 3 is connected to the electronic circuit 10 of the camera 2. Here, it is configured as a serializer-deserializer interface. Hereto, the control device 3 comprises a deserializer 25. Further, it is here outlined that a serializer 26 of this interface is arranged on the side of the camera 2. The connection cable between the control device 3 and the electronic circuit 10 of the camera 2 is preferably a coax harness.

Here, the electronic circuit 10 comprises a power management integrated circuit 27, which is configured to preset any voltage provided to the camera 2. In particular, a primary voltage regulator 13 of the power management integrated circuit 27 is configured to supply the at least one secondary voltage regulator 14 of the voltage regulator device 12 and/or the switch 11 of the heating device 9 with energy, as it is here exemplarily outlined for the switch 11.

In other words, FIG. 6 shows how the camera 2 is connected to the control device 3 via a SerDes interface, that is via the deserializer 25 and the serializer 26. In order to supply the camera 2 with current from the control device 3, the power over coax technology (PoC) is employed, that is the power over coax filters 19 are provided. The SerDes interface allows a bidirectional communication such that the control device 3 may turn on and off an electronic heating switch (switch 11). A PMIC (Power Management Integrated Circuit) is used, that is the power management integrated circuit 27, to regulate all of the voltages at the camera 2. The primary controller in the PMIC supplies all of the secondary controllers and the switch 11 with current. The switch 11 in turn determines whether or not the current flows to the heating device 9. In this application, an enable pin of the switch 11 is remotely controlled from the control device 3. This is achieved by an I2C interface between the control device 3 and the PMIC (via the serializer 26, which acts like an I2C bridge). Other interfaces and/or communication protocols may be used instead of or additional to the I2C interface. The PMIC has a GPO (General Purpose Output) pin, which is connected to the enable pin of the switch 11. In order to turn on or off the heating device 9, an I2C command is transmitted to the PMIC, to switch the GPO pin. For current measurement, a current sense resistor 22 between the negative terminal of the heating device 9 and the electrical ground is used for current measurement. The voltage across this resistor is measured by an ADC (analog-to-digital converter), that is the analog-to-digital converter 23, in the serializer 26. Alternatively, it may also be effected by a separate ADC. The control device 3 may remotely readout the value of the ADC and calculate the current flowing through the heating device 9. Here, the temperature sensor 30 is in the serializer 26 and in the image sensor 7. The control device 3 may readout these temperature sensors 30 also via the communication link between the camera 2 and the control device 3 to determine the temperature thereof and thereby the maximum temperature of the camera 2. This information may be used to turn on or off the heating device 9 at certain temperature thresholds.

The system 5 may be configured to adjust the energy, at which the heating device 9 is supplied (here not outlined), by means of an adjustable voltage regulator 13, 14 included by the electronic circuit 10 and/or a pulse width modulation.

FIG. 7 shows possible monitoring functions for operating the heating device 9. In a method step S1, the state information 31 is determined here by means of the respective state determining device 20. Here, it may exemplarily include a voltage measurement value 32, a current measurement value 33 and/or a temperature measurement value 34, that is it may describe the voltage value, the current value and the temperature value, respectively. The respective measurement value may be determined by calculations and/or directly measured.

In case of the voltage measurement value 32 and/or the current measurement value 33, it may be examined in a method step S2 if the determined state information 31 is outside of a respective value range 35, wherein different ranges of values 35 are here preset for current and voltage. If this is the case, either an error message 36 is provided and/or a control command for the heating device 9 is provided, which presets that the heating device 9 is at least paused and preferably deactivated. These measures, that is the error message 36 as well as pausing or deactivating the heating device 9, are effected in a method step S3. If it is determined that the determined state information 31 is within the respective value range 35, the method step S1 may be repeated. The method step S1 is preferably continuously effected.

In a method step S4, the temperature measurement value 34 may be examined to the effect if it is less than a preset minimum temperature threshold 37. The minimum temperature threshold 37 is for example at the freezing point or around the freezing point. If the temperature measurement value 34 and thus the determined temperature value is less than the minimum temperature threshold 37, a control command is provided, which presets that the heating device 9 is activated as it is the case in the method step S6. However, if the temperature measurement value 34 is greater than or equal to the preset minimum temperature threshold 37, the heating device 9 may for example remain deactivated (method step S5).

Now, it may be examined if the determined temperature measurement value 34 is greater than a preset maximum temperature threshold 38. The maximum temperature threshold 38 is greater than the minimum temperature threshold 37. If this is the case, the error message 36 is for example also provided and/or a control command is provided, which presets that the heating device 9 is at least paused, in particular deactivated. However, if the maximum temperature threshold 38 is not reached, this examination may for example be continuously effected again and again or the method step S1 may be effected, that is the state information 31 may be again and again newly determined.

Overall, the examples show a possibility how an electronic implementation of an interface between the control device 3 and the camera 2 may be realized for stably performing and examining a heating device 9 in a camera 2 provided for the motor vehicle area.

1. A system for operating a heating device of a camera for a motor vehicle, comprising:
a control device and an electronic circuit of the camera,
wherein the electronic circuit comprises at least one switch for the heating device and a voltage regulator device, which comprises a primary voltage regulator and in particular at least one secondary voltage regulator,
wherein:
the control device is configured to provide a voltage to the primary voltage regulator of the voltage regulator device;
the primary voltage regulator is configured to reduce the voltage, which is provided to the switch, to a constant voltage level; and
the system is configured to operate the heating device with the provided reduced voltage.

2. The system according to claim 1, wherein the electronic circuit comprises a state determining device, which is configured to determine a state information describing a current state of the heating device, and to provide the determined state information to the control device and/or to a control unit of the electronic circuit, wherein the control device and/or the control unit are configured to provide a control command for the heating device depending on the determined state information.

3. The system according to claim 2, wherein the state determining device comprises at least one current sense resistor with a preset resistance connected in series with the heating device and an analog-to-digital converter and is configured to capture a voltage drop on the at least one current sense resistor by means of the analog-to-digital converter and to determine a current value as the state information considering the captured voltage and the preset resistance.

4. The system according to claim 2, wherein the state determining device comprises at least one electronic switch, which comprises an integrated current measuring function, and is configured to determine a current value as the state information by means of the current measuring function.

5. The system according to claim 2, wherein the state determining device comprises at least one analog-to-digital converter which is coupled to a positive terminal of the heating device and is configured to determine a voltage value as the state information by the analog-to-digital converter.

6. The system according to claim 3, wherein the control device /or the control unit are configured to examine if the determined state information is outside of a respective value range and when this is the case, to provide an error message and/or a control command, which presets that the heating device is at least paused in

7. The system according to claim 2, wherein the state determining device comprises at least one temperature sensor and is configured to determine a temperature value as the state information by means of the temperature sensor.

8. The system according to claim 7, wherein the temperature sensor is arranged within the camera such that the determined temperature value describes an inside temperature of the camera, and/or is configured as an environmental temperature sensor such that the determined temperature value describes an environmental temperature of an environment of the camera.

9. The system according to claim 7, wherein the control device and/or the control unit are configured to examine if the determined temperature value is less than a preset minimum temperature threshold, and only when this is the case, to provide a control command, which presets that the heating device is activated.

10. The system according to claim 9, wherein the control device and/or the control unit are configured to continuously examine while the heating device is activated if the determined temperature value is greater than a preset maximum temperature threshold, which is greater than the minimum temperature threshold, and when this is the case, to provide an error message and/or to provide a control command, which presets that the heating device is at least paused.

11. The system according to claim 1, wherein the system is configured to adjust the energy, with which the heating device is supplied, by means of an adjustable voltage regulator included in the electronic circuit and/or a pulse width modulation.

12. The system according to claim 1, wherein the electronic circuit comprises a power management integrated circuit, which is configured to preset any voltage provided to the camera, wherein a primary voltage regulator of the power management integrated circuit is configured to supply at least the secondary voltage regulator of the voltage regulator device and/or the switch of the heating device with energy.

13. A motor vehicle, which comprises a camera with a heating device and a system according to claim 1.

14. The motor vehicle according to claim 12, wherein the control device is a control device of the motor vehicle external to the camera and/or the control unit is a microcontroller integrated in the electronic circuit.

15. A method for operating a heating device of a camera for a motor vehicle by means of a system of a control device and an electronic circuit of the camera, wherein the electronic circuit comprises at least one switch for the heating device and a voltage regulator device, which comprises a primary voltage regulator and at least one secondary voltage regulator, wherein the method comprises:
providing a voltage for the primary voltage regulator of the voltage regulator device by the control device;
reducing the voltage, which is provided to the switch of the heating device, to a constant voltage level by means of the primary voltage regulator; and
operating the heating device with the provided reduced voltage.
